(19) United States
(12) Patent Application Publication
(10) Pub. No.: US 2024/0136732 A1
(43) Pub. Date: Apr. 25, 2024

(54) ANTENNA DEVICE

(71) Applicant: YOKOWO CO., LTD., Chiyoda-ku, Tokyo (JP)

(72) Inventors: Hirotoshi MIZUNO, Tomioka-Shi, Gunma (JP); Takashi NOZAKI, Tomioka-Shi, Gunma (JP)

(73) Assignee: YOKOWO CO., LTD., Chiyoda-ku, Tokyo (JP)

(21) Appl. No.: 18/278,409

(22) PCT Filed: Feb. 4, 2022
(86) PCT No.: PCT/JP2022/004480

§ 371 Date: Aug. 22, 2023

(30) Foreign Application Priority Data
Feb. 25, 2021 (JP) 2021-028102

(51) Int. Cl. H01Q 19/00; H01Q 9/04

(52) U.S. Cl. CPC H01Q 19/005; H01Q 9/0407

(57) ABSTRACT

An antenna device including an antenna having a radiation element capable of receiving a signal of a predetermined frequency band, and a metallic portion having at least one parasitic slot provided around the antenna.

### TECHNICAL FIELD

The present disclosure relates to an antenna.

### BACKGROUND ART

PTL 1 discloses an antenna device including a patch antenna.

### Citation List

### Patent Literature

[PTL 1] Japanese Patent Application Publication No. 2007-116739

### SUMMARY OF INVENTION

### Technical Problem

Incidentally, when the area of a ground plane of an antenna device is increased, the directivity of the antenna device deteriorates in some cases because of, for example, a decrease in gain at a high elevation angle of the patch antenna.

An example of an object of the present invention is to improve the directivity of the antenna device. Other objects of the present invention will be apparent from descriptions in the present specification.

### Solution to Problem

An aspect of the present invention is an antenna device that includes: an antenna including a radiation element capable of receiving a signal of a predetermined frequency band; and a metallic portion, including at least one parasitic slot provided around the antenna.

According to an aspect of the present invention, the directivity of the antenna device is improved.

### BRIEF DESCRIPTION OF DRAWINGS

FIG. 1 is a perspective view of an antenna device 10.

FIG. 2 is a plan view of the antenna device 10.

FIG. 3 is a perspective view of a patch antenna 30.

FIG. 4 is a cross-sectional view of the patch antenna 30.

FIG. 5 is a diagram describing a theoretical circle C on a front surface of a ground plane 20.

FIG. 6 is a diagram illustrating a relationship between elevation angle and gain of an antenna device A and the antenna device 10.

FIG. 7 is a diagram illustrating a relationship between a length L and an average gain.

FIG. 8 is a diagram illustrating a relationship between the elevation angle and the gain when the length L is changed.

FIG. 9 is a diagram illustrating a relationship between a distance D and the average gain.

FIG. 10 is a diagram illustrating a relationship between the elevation angle and the gain when the distance D is changed.

FIG. 11 is a plan view of an antenna device 100.

FIG. 12 is a plan view of an antenna device 101.

FIG. 13 is a plan view of an antenna device 102.

FIG. 14 is a diagram illustrating a relationship between the elevation angle and the gain of an antenna device X and the antenna devices 100 to 102.

FIG. 15 is a plan view of an antenna device 110.

FIG. 16 is a plan view of an antenna device 111.

FIG. 17 is a plan view of an antenna device 112.

FIG. 18 is a plan view of an antenna device 113.

FIG. 19 is a plan view of an antenna device 114.

FIG. 20 is a diagram illustrating a relationship between the elevation angle and the gain of the antenna device A, the antenna devices 111 and 112, and the antenna device 114.

FIG. 21 is a plan view of an antenna device 200.

FIG. 22 is a diagram illustrating a relationship between a frequency and the gain of an antenna device B.

FIG. 23 is a diagram illustrating a relationship between the frequency and the gain of an antenna device 200a.

FIG. 24 is a diagram of a relationship between the elevation angle and the gain of the antenna device B and the antenna device 200a.

FIG. 25 is a diagram illustrating a relationship between the frequency and the gain of an antenna device 200b.

FIG. 26 is a diagram of a relationship between the elevation angle and the gain of the antenna device B and the antenna device 200b.

FIG. 27 is a diagram illustrating a relationship between the frequency and the gain of an antenna device 200c.

FIG. 28 is a diagram of a relationship between the elevation angle and the gain of the antenna device B and the antenna device 200c.

FIG. 29 is a diagram of a relationship between the elevation angle and the gain of the antenna device 200c.

### DESCRIPTION OF EMBODIMENTS

At least the following matters are apparent from descriptions in the present specification and the appended drawings.

### <<<Antenna Device 10>>>

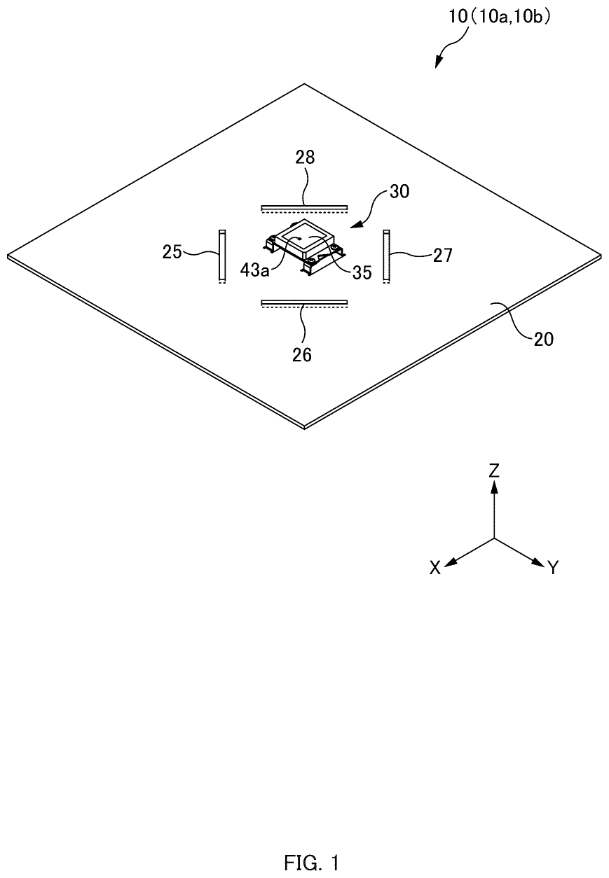

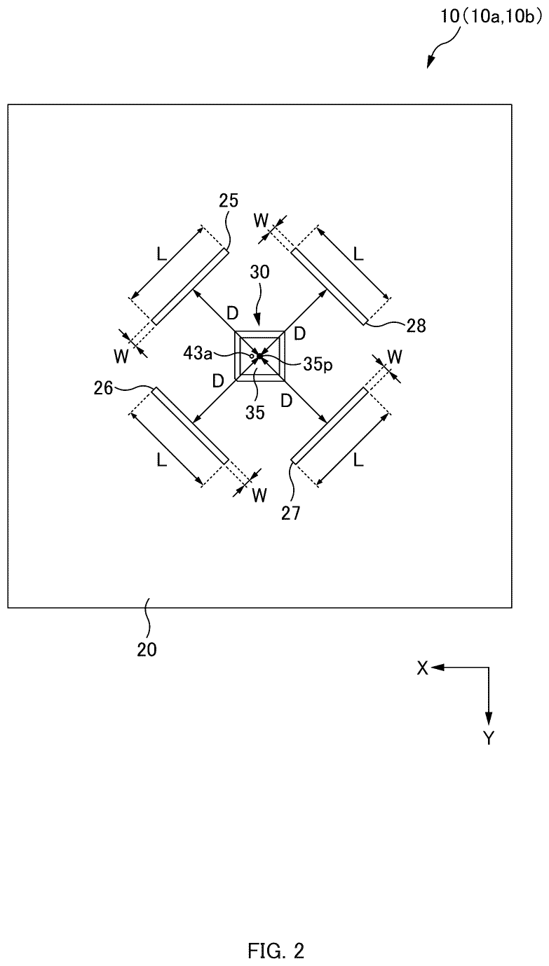

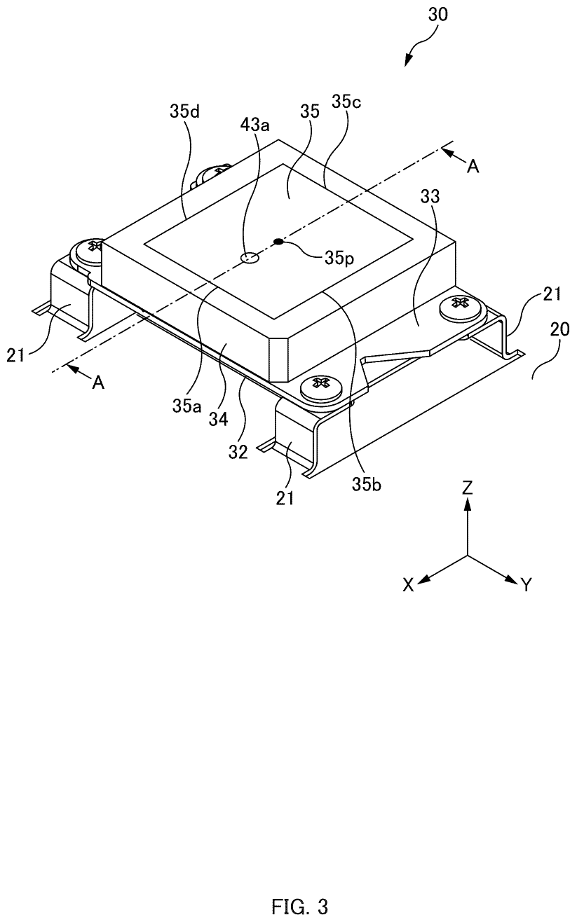

An overview of a configuration of an antenna device 10 is described with reference to FIGS. 1 to 3. FIG. 1 is a perspective view of the antenna device 10, and FIG. 2 is a plan view of the antenna device 10. Additionally, FIG. 3 is a perspective view of a patch antenna 30. Note that, in FIG. 2, only the patch antenna 30 of the antenna device 10 is illustrated, and a part of the configuration (a base portion supporting the patch antenna 30 and the like described later) is omitted for the sake of convenience.

In the present embodiment, a direction along a segment connecting a central point 35p of a radiation element 35 of the later-described patch antenna 30 and a feed point 43a is an X direction. Additionally, a right and left direction perpendicular to the X direction is a Y direction, and a vertical direction perpendicular to the X direction and the Y direction is a Z direction. Moreover, hereinafter, the same or similar constituents, members, and the like illustrated in the drawings are denoted by the same reference signs, and duplicated descriptions are omitted as appropriate.

The antenna device 10 is a vehicular antenna device mounted in a not-illustrated vehicle and includes a ground plane 20 and the patch antenna 30. The vehicular antenna device is stored in a hollow space between a roof panel of the vehicle and a roof lining on a ceiling surface inside a vehicle compartment, for example.

The ground plane 20 is a quadrangular metallic plate used as a ground of the patch antenna 30 and is installed on the roof lining of the vehicle (not illustrated), for example. The ground plane 20 includes four parasitic slots 25 to 28 formed around the patch antenna 30. Note that details of the slots 25 to 28 are described later. Additionally, although the ground plane 20 is quadrangular it is not limited thereto and may be a circular or oval plate-shaped member, for example. Moreover, the ground plane 20 may have a shape other than a plate shape as long as it is a member made of metal that functions as the ground.

The patch antenna 30 is, for example, an antenna for satellite digital audio radio service (SDARS) and receives a left-handed circularly polarized wave (a satellite signal) in a band of 2.3 GHz. Additionally, the patch antenna 30 is provided near the center of the ground plane 20. Note that a communication standard and a frequency band that the patch antenna 30 is able to receive are not limited to the above and may be another communication standard and frequency bandwidth.

### <<<Patch Antenna 30>>>

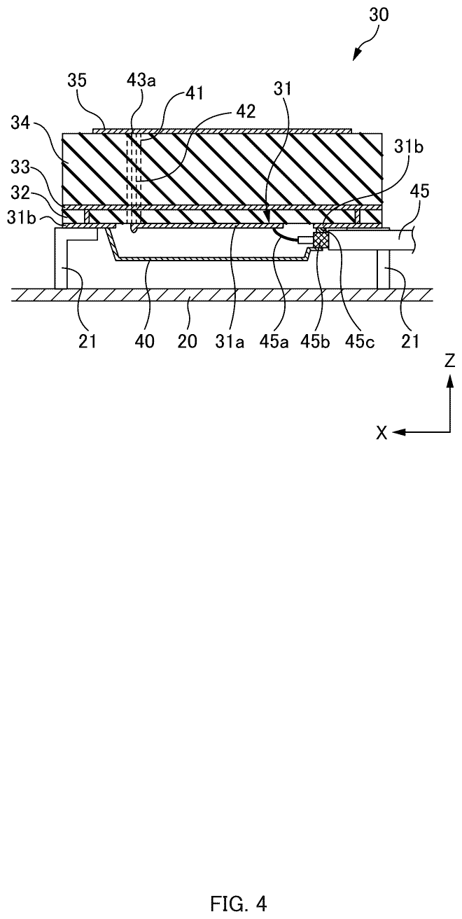

The patch antenna 30 is described below in detail with reference to FIGS. 3 and 4. Note that FIG. 4 is a cross-sectional view of the patch antenna 30 taken along an A-A line in FIG. 3. Note that hatched lines illustrated in FIG. 4 are provided for the sake of convenience in the drawing to clarify conductive patterns 31 and 33, a circuit board 32, a dielectric member 34, the radiation element 35, and a shield cover 40, which are described later.

The patch antenna 30 includes the circuit board 32 on which the conductive patterns 31 and 33 (details are described later) are formed, the dielectric member 34, the radiation element 35, and the shield cover 40.

The circuit board 32 is a dielectric plate material in which the conductive patterns 31 and 33 are respectively formed on a back surface (a surface in a Z axis negative direction) and a front surface (a surface in a Z axis positive direction) and is formed of glass epoxy resin, for example. Additionally, the pattern 31 includes a circuit pattern 31a and a ground pattern 31b.

For example, the circuit pattern 31a is a conductive pattern to which a signal line 45a of a coaxial cable 45 from an amplifier board (not illustrated) is coupled. Additionally, a braid 45b of the coaxial cable 45 is electrically coupled to the ground pattern 31b by solder 45c. Note that a configuration to couple the circuit pattern 31a and the radiation element 35 with each other is described later.

The ground pattern 31b is a conductive pattern to ground the patch antenna 30. The ground pattern 31b and four base portions 21 provided on the ground plane 20 formed of metal are electrically coupled to each other. In this case, each of the four base portions 21 is formed from a part of the ground plane 20 by bending so as to be able to support the patch antenna 30.

The ground pattern 31b is then grounded by the ground pattern 31b and the base portion 21 being electrically coupled to each other. Note that, for example, the metallic shield cover 40 for shielding the circuit pattern 31a is attached to a back surface of the circuit board 32.

The pattern 33 formed on the front surface of the circuit board 32 is a ground pattern that functions as a ground conductor plate (or a ground conductor film) of the patch antenna 30 and as a ground of a circuit (not illustrated). The pattern 33 is electrically coupled to the ground pattern 31b through a through-hole. Additionally, the ground pattern 31b is electrically coupled to the ground plane 20 through a fixing screw that fixes the circuit board 32 to the base portion 21, and the base portion 21. Accordingly, the pattern 33 is electrically coupled to the ground plane 20.

The dielectric member 34 is a substantially quadrangular plate-shaped member including a side parallel to the X axis and a side parallel to the Y axis. A front surface and a back surface of the dielectric member 34 are parallel to the X axis and the Y axis, and the front surface of the dielectric member 34 faces the Z axis positive direction while the back surface of the dielectric member 34 faces the Z axis negative direction. Additionally, the back surface of the dielectric member 34 is attached to the pattern 33 by double-faced tape, for example. Note that the dielectric member 34 is formed of a dielectric material such as ceramics.

The radiation element 35 is a substantially quadrangular conductive element smaller than the area of the front surface of the dielectric member 34 and is formed on the front surface of the dielectric member 34. Note that, in the present embodiment, a normal direction of a radiation surface of the radiation element 35 is the Z axis positive direction. Additionally, the radiation element 35 includes sides 35a and 35c parallel to the Y axis and sides 35b and 35d parallel to the X axis.

In this specification, “substantially quadrangular” means, for example, a shape formed of four sides, including a square and a rectangle, and at least some of the corners may be notched obliquely with respect to the side, for example. Additionally, in the “substantially quadrangular” shape, a notch (a recessed portion) and a projection (a protruding portion) may be provided in some of the sides. Moreover, although the radiation element 35 is “substantially quadrangular” in the patch antenna 30 it is not limited thereto and may be a circle, an oval, and a polygon other than a substantially quadrangular shape, for example. That is, the radiation element 35 may be any shape as long as it is a shape that is able to receive a signal (radio waves) of a desired frequency band.

A through-hole 41 penetrates the circuit board 32, the pattern 33, and the dielectric member 34. A feeder 42 that couples the circuit pattern 31a and the radiation element 35 with each other is provided inside the through-hole 41. Note that the feeder 42 couples the circuit pattern 31a and the radiation element 35 with each other in a state of being electrically insulated from the grounded pattern 33. Additionally, in the present embodiment, a point at which the feeder 42 is electrically coupled to the radiation element 35 is the feed point 43a.

Note that, as illustrated in FIG. 3, the feed point 43a is provided in a position deviated in an X axis positive direction from the central point 35p of the radiation element 35. It should be noted that the position of the feed point 43a is not limited thereto, and the feed point 43a may be provided in a position deviated in the X axis positive direction and a Y axis negative direction from the central point 35p of the radiation element 35, for example.

Note that the “central point 35p of the radiation element 35” is a central point of an outer edge shape of the radiation element 35, that is, a geometric center. The radiation element 35 for the single-feed system illustrated in FIG. 3 has a substantially rectangular shape in which the vertical and horizontal lengths are different so as to be able to transmit and receive a desired circularly polarized wave, for example.

Additionally, in the present embodiment, the patch antenna 30 is designed such that the central point 35p coincides with the center of the patch antenna 30 in an XY plane. The “center of the patch antenna 30” is, for example, the geometric center of the patch antenna 30 except the base portion 21 in a plane view of the X-Y plane obtained by viewing the patch antenna 30 from the Z axis positive direction.

Moreover, “substantially rectangular” is a shape included in the above-described “substantially quadrangular”. Therefore, the “central point 35p of the radiation element 35” is a point at which diagonals of the radiation element 35 cross each other. Note that “substantially rectangular” is a shape included in the above-described “substantially quadrangular”.

Although a configuration in which there is only one feeder coupled to the radiation element, which is the feeder 42, is described in the present embodiment, a feeder coupled to the radiation element 35 may be added to provide two or four lines, and thus a double-feed system or a quadruple feed system may be employed. Note that, as with the feeder 42, since the added feeder(s) can be provided through a through-hole (not illustrated) penetrating through the dielectric member 34 and so on, detailed descriptions of the configurations thereof are omitted herein.

Additionally, as with the feed point 43a, an added feed point can be provided in a position deviated in X axis positive and negative directions or Y axis positive and negative directions from the central point 35p of the radiation element 35. For example, in the double-feed system, the feed points are provided in a position deviated in the X axis positive direction from the central point 35p and in a position deviated in the Y axis negative direction from the central point 35p. In the quadruple-feed system, the feed points are provided in positions deviated respectively in the X axis positive and negative directions from the central point 35p and in positions deviated respectively in the Y axis positive and negative directions from the central point 35p. Additionally, distances to the central point 35p from those feed points provided in the positions deviated from the central point 35p are equal to each other.

Moreover, when a double-feed system or a quadruple-feed system is used, for example, the radiation element 35 has a substantially square shape in which the vertical and horizontal lengths are equal to each other so as to be able to transmit and receive a desired circularly polarized wave. Note that “substantially square” is a shape included in the above-described “substantially quadrangular”.

### <<<Slots>>>

### ==Slot Shape==

The slot 25 in FIGS. 1 and 2 is a parasitic opening (or a hole) formed in the ground plane 20 so as to emit (or reflect) radio waves of the desired frequency band received by the patch antenna 30. The slot 25 of the present embodiment is a quadrangle having a length L in a longitudinal direction and a length W in a transverse direction according to an operating wavelength of the desired frequency band.

In this case, the “operating wavelength (a wavelength of the desired frequency band)” is a wavelength corresponding to a desired frequency of the desired frequency band in which the patch antenna 30 is used and is specifically a wavelength corresponding to the center frequency of the desired frequency band, for example.

For example, since the patch antenna 30 is an antenna used for satellite digital audio radio service, the center frequency is substantially 2.3 GHz. Accordingly, the operating wavelength is a wavelength corresponding to substantially 2.3 GHz.

In the slot 25, which is described in detail later, so as to be able to emit radio waves of the operating wavelength (hereinafter, λ), the length L is substantially half the operating wavelength (λ/2), and the length W is a length sufficiently shorter than the length L.

Additionally, since each of the slots 26 to 28 is a quadrangular opening like the slot 25, detailed descriptions thereof are omitted herein. Note that although each of the slots 25 to 28 has a quadrangular shape with the length L and the length W in the present embodiment, the shape is not limited thereto. Since it is enough for the slots 25 to 28 to be able to emit radio waves of the desired frequency band, they may be a substantially quadrangular shape, a polygon other than a quadrangle, a circle, an oval, or a cross shape, for example.

### ==Slot Position==

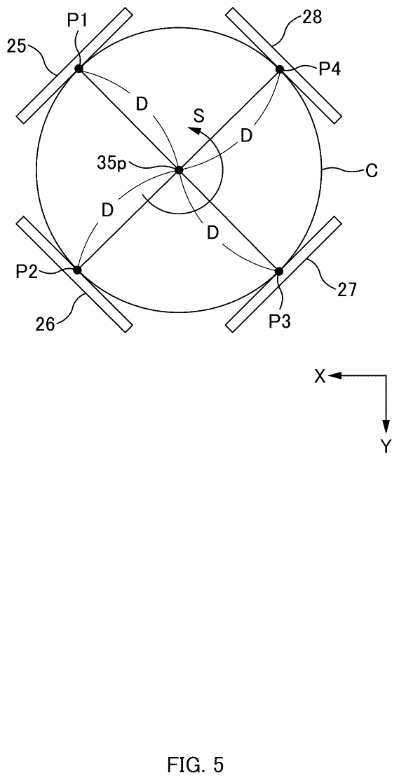

The slots 25 to 28 are provided around the patch antenna 30 so as to be able to enhance the directivity of the patch antenna 30. Specifically, for example, as illustrated in FIG. 5, each of the slots 25 to 28 is provided at equal intervals on a circumference of a theoretical circle (hereinafter, a circle C) in which the position of a front surface of the ground plane 20 that corresponds to the central point 35p of the radiation element 35 is set as the center, and the radius is a distance D. Note that the distance D in the present embodiment is half the length (λ/2) of the operating wavelength, for example.

“Around the patch antenna” on which the slots are arranged is, for example, a region within a region around the patch antenna 30 in which the directivity of the patch antenna 30 is enhanced by providing slots. Additionally, in FIG. 5, the direction of the circling of the left-handed circularly polarized waves received by the radiation element 35 is indicated by an arrow S for reference.

The slot 25 is provided in the ground plane 20 such that, of the two long sides of the slot 25, the midpoint of the side on the radiation element 35 side of the two sides contacts a point P1 along a circumference of the circle C in the X axis positive direction and the Y axis negative direction. Additionally, the slot 26 is provided to contact a point P2 along the circumference of the circle C in the X axis positive direction and the Y axis positive direction, and the slot 27 is provided to contact a point P3 along the circumference of the circle C in the X axis negative direction and the Y axis positive direction. Moreover, the slot 28 is provided to contact a point P4 along the circumference of the circle C in the X axis negative direction and the Y axis negative direction.

In this case, in the present embodiment, each of the points P1 to P4 is positioned at equal intervals (every 90°) along the circumference of the circle C. Accordingly, each of the slots 25 to 28 is also provided at every 90° along the circumference of the circle C. Note that, although the four slots are arranged at every 90° (equal intervals) in this case, slot arrangement is not limited thereto, and the angles between the slots may be different from each other.

In such a case, the longitudinal direction of each of the slots 25 to 28 is parallel to a tangent of the points P1 to P4 of the circle C. Accordingly, the longitudinal direction of each of the slots 25 to 28 is the same as the circling direction of the circularly polarized wave received by the patch antenna 30. That is, the slots 25 to 28 are arranged along the circling direction of the circularly polarized wave.

Note that, although the radio waves received by the patch antenna 30 are left-handed circularly polarized waves in the present embodiment, for example, even for right-handed circularly polarized waves the slots 25 to 28 are still arranged along the circling direction of the circularly polarized wave.

### ==Simulation Conditions==

In this case, gains of the antenna device 10 and an antenna device of a comparative example (hereinafter, referred to as an antenna device A) were calculated under predetermined conditions (hereinafter, referred to as “predetermined conditions”) such as a size of the dielectric member 34, a size of the radiation element, a total thickness of the dielectric member 34 and the radiation element 35, a height from a surface of the ground plane 20 to a surface of the radiation element 35, a size of the ground plane, and feed system. Note that the antenna device A (not illustrated) is the antenna device 10 that is not provided with the slots 25 to 28. Additionally, in the simulation of the antenna device 10 and the antenna device A, for the sake of convenience a model omitting the circuit pattern 31a and the like that have little effect on the gain is used.

In this case, the frequency of the received radio waves is 2320 MHz, with the operating wavelength A corresponding thereto being substantially 130 mm. Accordingly, the length L (=64 mm) and the distance D (=64 mm) of the slots 25 to 28 correspond to substantially half the operating wavelength A. The length W of the slots 25 to 28 is 5 mm.

Note that, in this case, the distance and the length are expressed by using “substantially” as in “substantially half the operating wavelength A”. This is because the operating wavelength A cannot necessarily be expressed as a divisible integer, and because an electrical length of the slot formed in the actual ground plane 20 changes due to various factors such as the patch antenna 30 and the like. Accordingly, in the present embodiment, when the distance and the length are described using “substantially”, there is included therein a value deviated from a precise value by a predetermined value (for example, one thirty-second of the operating wavelength λ). Note that although in this case the “predetermined value” is one thirty-second of the operating wavelength λ, the predetermined value is not limited thereto since it is a value that changes due to the ground plane 20, the patch antenna 30, and so on forming the antenna device 10.

### ==Simulation Results==

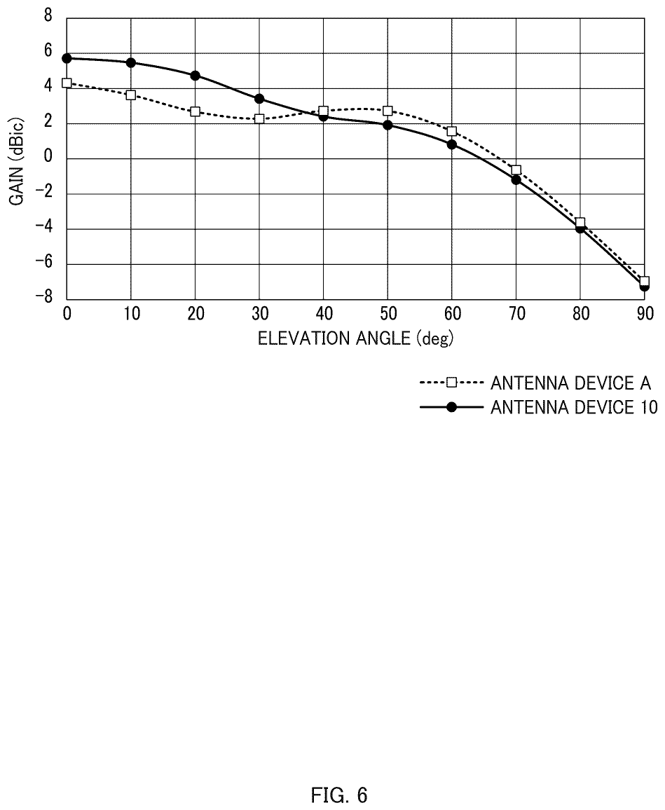

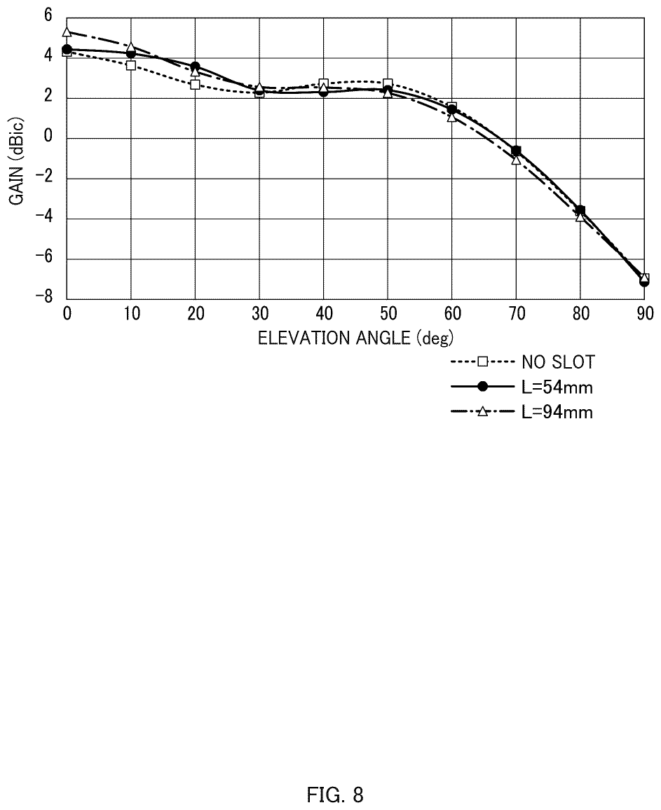

FIG. 6 is a diagram illustrating a relationship between elevation angle (horizontal axis) and average gain (vertical axis) in each of the antenna device A and the antenna device 10. Note that, in this case, in the elevation angle, the zenith angle is 0°, and an angle in the horizontal direction is 90°. Additionally, in FIG. 6, a calculation result of the antenna device A is indicated by a dotted line, and a calculation result of the antenna device 10 is indicated by a solid line. Note that a □ mark on the dotted line and a • mark on the solid line indicate the position of a numerical value on the vertical axis with respect to a numerical value on the horizontal axis, and the indication using the □ mark and the • mark is made to distinguish the position for the sake of convenience. Note that the same applies to the later-described FIGS. 8, 10, 14, 20, 24, 26, 28, and 29, and the same applies to a Δ mark on a dashed-dotted line and a x mark on a dashed-two dotted line.

Additionally, hereinafter, in the present embodiment, a “high elevation angle” is, for example, a range of elevation angles of 0° to 30°, a “middle elevation angle” is, for example, a range of elevation angles of 30° to 60°, and a “low elevation angle” is, for example, a range of elevation angles of 60° to 90°.

As illustrated in FIG. 6, the gain of the antenna device A gradually decreases from the elevation angle 0° (4.3 dBic) and decreases to 2.3 dBic at the elevation angle 30°. Thereafter, the gain of the antenna device A rises as the elevation angle increases, reaches 2.7 dBic at the elevation angle 50°, and decreases again. Accordingly, the antenna device A has the directivity in which the gain deteriorates at the high elevation angle (for example, 30°).

On the other hand, the gain of the antenna device 10 gradually decreases as the elevation angle increases from a zenith direction at the elevation angle 0° (5.7 dBic), and includes no point at which the gain increases.

Additionally, although an average gain at the elevation angles 0° to 60° of the antenna device A is substantially 3.0(≈2.99) dB, an average gain at the elevation angles 0° to 60° of the antenna device 10 is substantially 3.8 dB, which is greater by 0.8 dB. Accordingly, for example, as an antenna device that receives radio waves transmitted from a satellite, the antenna device 10 enhances the average gain at the high to middle elevation angles and has ideal directivity.

Thus, with the parasitic slots 25 to 28 being provided around the patch antenna 30, the gain at the high to middle elevation angles of the patch antenna 30 is enhanced and the directivity is improved. As a result, the patch antenna 30 can efficiently receive a radio waves that come from a satellite, for example.

<<<about Change in Slot Shape and Installation Conditions>>>

Next, a case where the slot shape and the installation conditions (the length L, the distance D, the arrangement, and the number) are changed is described. Note that two or more conditions described later may be changed and combined to be applied. For example, two of the installation conditions, the length L of the slot and the number of the slots, may be changed, or three conditions, the length L, the distance D, and the arrangement, may be changed.

### ==Changing Slot Length L==

In this case, the properties of an antenna device 10a when the length L of the slots 25 to 28 is changed are examined. Note that, in this case, the length L of all the four slots 25 to 28 is changed in the same way. Additionally, various conditions and the like of the antenna device 10a other than the length L of the slots 25 to 28 (for example, the length W of the slot and the distance D) are the same as the above-described predetermined conditions.

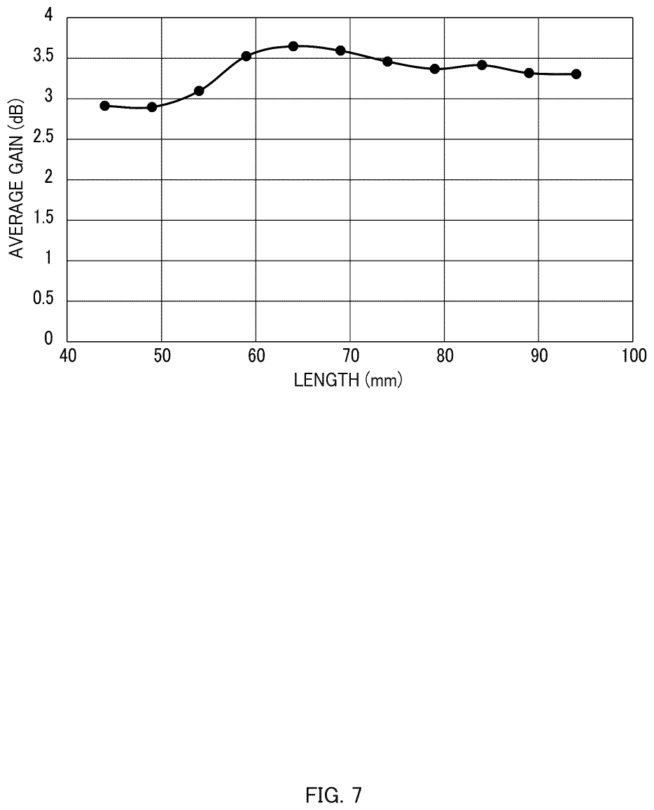

FIG. 7 is a diagram illustrating a relationship between the average gain (dB) at the elevation angles 0° to 60° and the length L of the slots 25 to 28 in the antenna device 10a. As illustrated in FIG. 7, until the length L reaches substantially three-eighths λ (3λ/8) of the operating wavelength, which is 44 mm or 49 mm, the average gain at the elevation angles 0° to 60° in the antenna device 10 is slightly smaller than the average gain of a case of no slot (substantially 3.0 dB).

On the other hand, when the length L reaches 54 mm (substantially seven-sixteenths of the operating wavelength), the average gain at the elevation angles 0° to 60° in the antenna device 10 is 3.1 dB and is thus greater than the average gain of a case of no slot (substantially 3.0 dB).

Then, when the length L reaches 64 mm (substantially half the operating wavelength), the average gain at the elevation angles 0° to 60° in the antenna device 10 is a peak value (3.65 dB). Once the length L becomes longer than 64 mm, the average gain decreases gradually. It should be noted that, for example, even if the length L is increased to 94 mm (substantially four-thirds of the operating wavelength), the average gain at the elevation angles 0° to 60° in the antenna device 10 is 3.3 dB, which is greater than the average gain in a case of no slot (substantially 3.0 dB).

FIG. 8 is a diagram illustrating a relationship between the elevation angle (the horizontal axis) and the gain (the vertical axis) in each of a case of no slot, the length L of the slot=54 mm, and the length L of the slot=94 mm. Note that results for “no slot” are the same as the results for the antenna device A in FIG. 6 described above.

As indicated by a solid line in FIG. 8, in the antenna device 10a in which the length L is 54 mm, the gain in the high elevation angle range is enhanced more than that of a dotted line (no slot). Additionally, as indicated by a dashed-dotted line in FIG. 8, the gain at the high elevation angle of the length L=94 mm is further enhanced than that of the dotted line (no slot). Thus, when the length L is changed from 54 mm to 94 mm based on FIG. 7, the average gain at the high to middle elevation angles of the antenna device 10a is enhanced more than a case of providing no slot, and it is possible to obtain the ideal directivity.

### ==Changing Distance D==

Next, the properties of an antenna device 10b when the distance D is changed out of the installation conditions of the slots 25 to 28 are examined. Note that, in this case, the distance D of all the four slots 25 to 28 is changed in the same way. Additionally, various conditions of the antenna device 10b other than the distance D (for example, the length L of the slot, the length W, and so on) are the same as the above-described predetermined conditions.

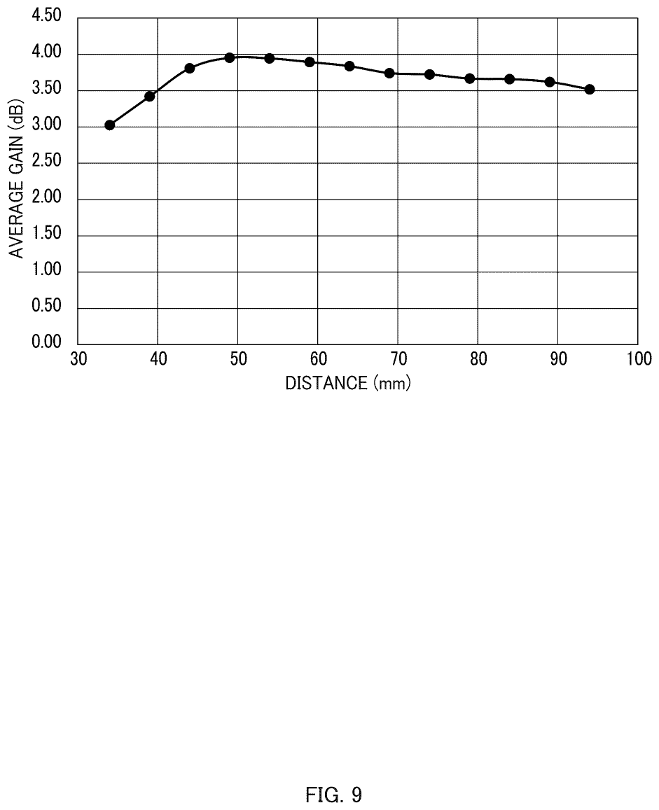

FIG. 9 is a diagram illustrating a relationship between the average gain (dB) at the elevation angles 0° to 60° in the antenna device 10b and the distance D of the slots 25 to 28. In this case, the distance D is changed by 5 mm from 34 mm (substantially one-fourth the wavelength of the operating wavelength) to 94 mm (substantially three-fourths of the operating wavelength).

When the distance D is 34 mm, the average gain at the elevation angles 0° to 60° is 3.03 dB, which is greater than the average gain of a case of no slot (2.99 dB). Then, when the distance D is 49 mm (substantially three-eighths of the operating wavelength), the average gain at the elevation angles 0° to 60° is 3.95 dB, which is the highest. Thereafter, when the distance D is gradually increased from 49 mm, the average gain at the elevation angles 0° to 60° declines moderately. It should be noted that the average gain at the elevation angles 0° to 60° when the distance D is 94 mm (substantially three-fourths of the operating wavelength) is 3.52 dB, which is a higher value than the average gain in a case of no slot (2.99 dB).

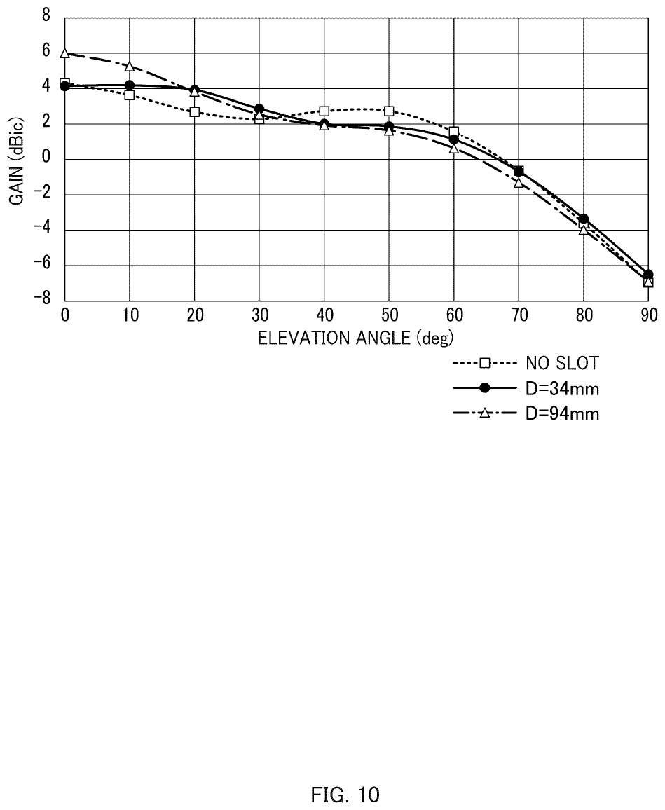

Additionally, FIG. 10 is a diagram illustrating a relationship between the elevation angle (horizontal axis) and the gain (vertical axis) in each of no slot, the distance D=34 mm, and the distance D=94 mm. Note that results for “no slot” are the same as the results for the antenna device A in FIG. 6 described above.

As indicated by a solid line in FIG. 10, in the antenna device 10b in which the distance D is 34 mm, the gain in the high elevation angle range is enhanced more than that of a dotted line (no slot). Additionally, as indicated by a dashed-dotted line in FIG. 10, the gain at the high elevation angle of the distance D=94 mm is further enhanced than that of a dotted line (no slot). Thus, when the distance D is changed from 34 mm to 94 mm based on FIG. 9, the average gain at the high to middle elevation angles of the antenna device 10b is enhanced more than a case of providing no slot, and it is possible to obtain the ideal directivity.

### ==Changing Slot Arrangement==

Here, a case where the arrangement of the four slots in the ground plane 20 is changed is described. Note that, in this case, various conditions of the antenna device other than the arrangement of the four slots 25 to 28 (for example, the length L of the slot, the length W, the size of the patch antenna 30, and so on) are the same as the above-described predetermined conditions. Additionally, in this case, changing the arrangement, which is described later in detail, includes a case of changing the distance D of each of the four slots and a case of rotating the positions of the four slots while maintaining the distance D, for example.

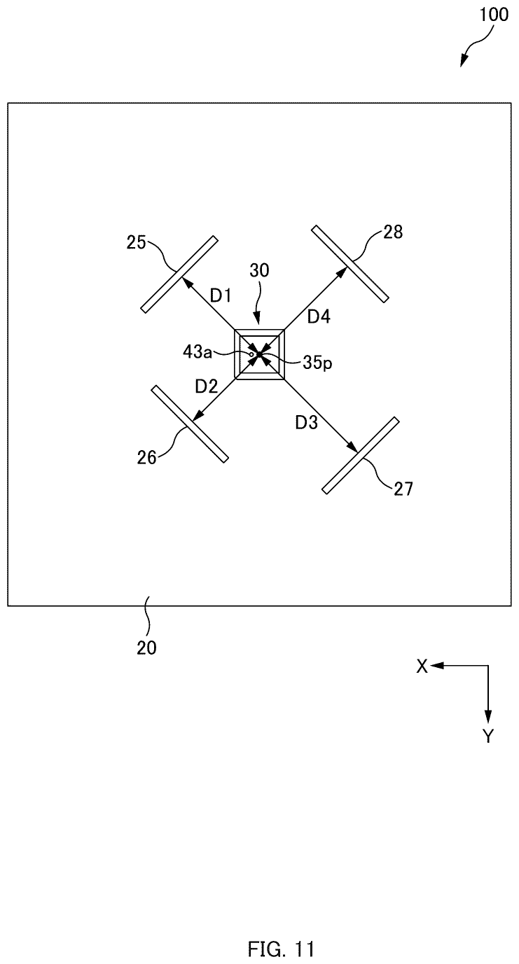

FIG. 11 is a plan view of an antenna device 100 in which the distance D of each of the slots 25 to 28 is changed. In the antenna device 100, from the central point 35p, a distance D1 to the slot 25 is 74 mm, and a distance D2 to the slot 26 is 64 mm. Additionally, from the central point 35p, a distance D3 to the slot 27 is 94 mm, and a distance D4 to the slot 28 is 84 mm.

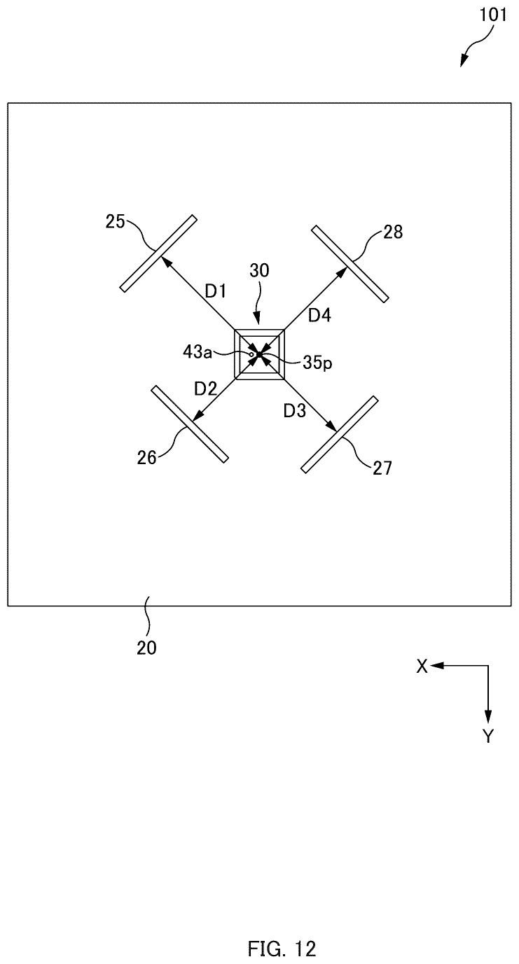

FIG. 12 is a plan view of an antenna device 101 in which the distance D of each of the slots 25 to 28 is changed as with FIG. 11. In the antenna device 101 in FIG. 12, the distances D1 and D3 are switched from the arrangement in FIG. 11. Specifically, in the antenna device 101, the distance D1 is 94 mm, and the distance D3 is 74 mm. On the other hand, the distances D2 and D4 are 64 mm and 84 mm, respectively.

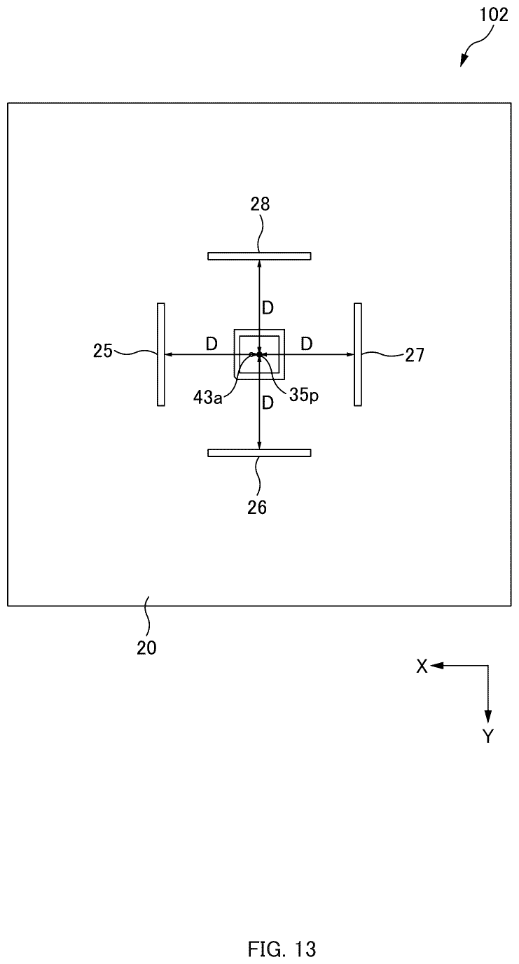

FIG. 13 is a plan view of an antenna device 102 in which the four slots are arranged such that the longitudinal direction of the slot is parallel to each side of the radiation element 35. Note that, in the antenna device 102 in FIG. 13, the distance D to the four slots is not changed from the distance D (=64 mm) of the antenna device 100, but the arrangement angle of the slots 25 to 28 is changed.

Specifically, the slot 25 is provided such that the center of the side in the longitudinal direction of the slot 25 is positioned at a position separated by the distance D from the central point 35p of the radiation element 35 in the X axis positive direction. Additionally, the same applies to the slots 26 to 28 as with the slot 25.

The slot 26 is provided at a position separated by the distance D from the central point 35p in the Y axis positive direction, and the slot 27 is provided at a position separated by the distance D from the central point 35p in the X axis negative direction. Additionally, the slot 28 is provided at a position separated by the distance D from the central point 35p in the Y axis negative direction. As a result, in the antenna device 102, in each of the slots 25 to 28, the points crossing the central point 35p are arranged at every 90° in the theoretical circle on the front surface of the ground plane 20 in which the center is the central point 35p and the radius is the distance D.

In this case, calculation results of the average gains at the elevation angles 0° to 60° of the respective antenna devices 100 to 102 are 3.63 dB, 3.72 dB, and 3.67 dB, which are all greater than the average gain at the elevation angles 0° to 60° of the antenna device A (2.99 dB).

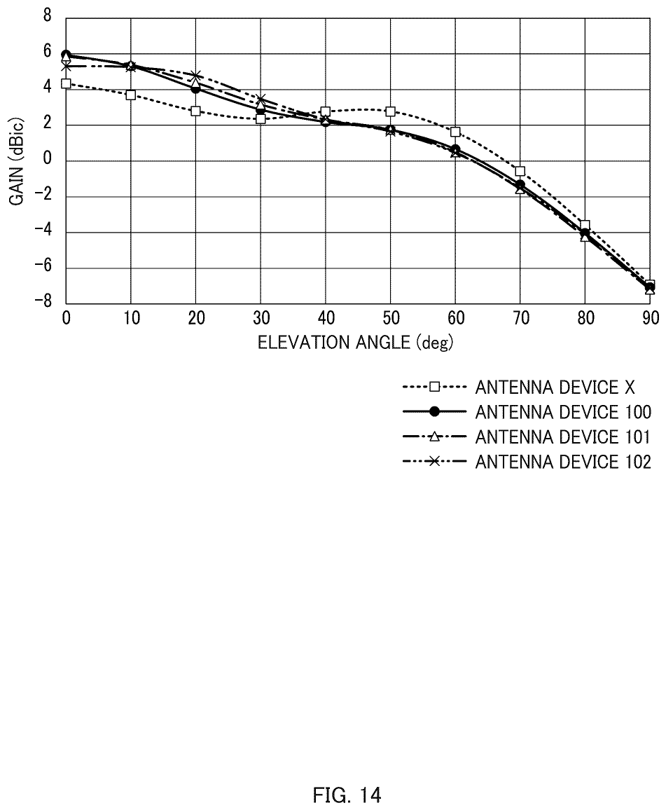

Additionally, FIG. 14 is a diagram illustrating a relationship between the elevation angle (horizontal axis) and the gain (vertical axis) in no slot (the antenna device A) and in each of the antenna devices 100 to 102. In FIG. 14, a dotted line is a waveform of an antenna device with no slot (the antenna device A), and a solid line, a dashed-dotted line, and a dashed-two dotted line are waveforms of the antenna devices 100 to 102, respectively.

As illustrated in FIG. 14, at high elevation angles the gain of each of the antenna devices 100 to 102 is greater than the gain of the antenna device A. The gain of each of the antenna devices 100 to 102 then gradually declines as the elevation angle increases from the zenith angle. Accordingly, even when the antenna devices 100 to 102 in which the arrangement of the slots 25 to 28 is changed are used, it is possible to enhance the average gain at the high to middle elevation angles of the antenna devices 100 to 102 and to obtain the ideal directivity.

### ==Changing Number of Slots==

Here, a case where the number of the slots provided in the ground plane 20 is changed is described. Note that, in this case, various conditions of the antenna device other than the number of the slots (for example, the length L of the slot, the length W, the size of the patch antenna 30, and so on) are the same as the above-described predetermined conditions.

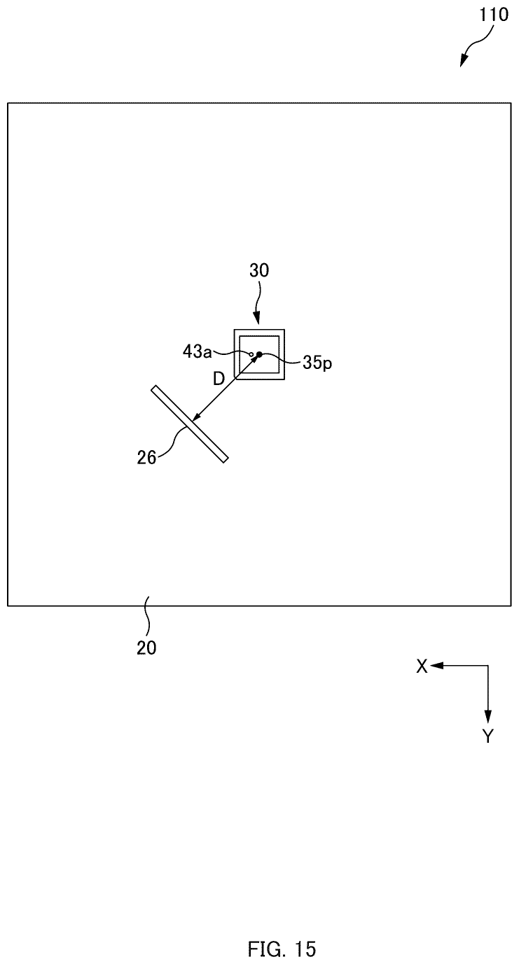

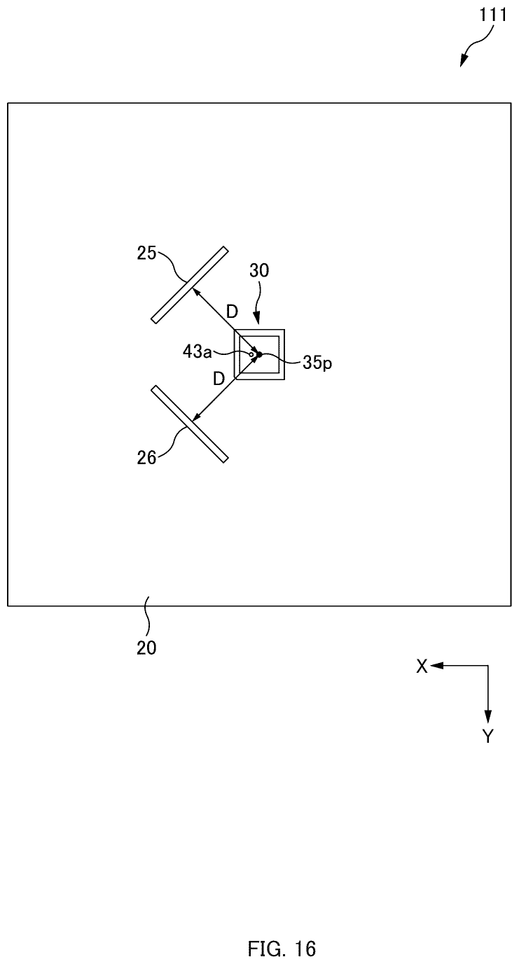

FIG. 15 is a plan view of an antenna device 110 including one slot. The antenna device 110 is provided with only the slot 26 out of the slots 25 to 28. FIGS. 16 to 18 are plan views of antenna devices 111 to 113 including two slots.

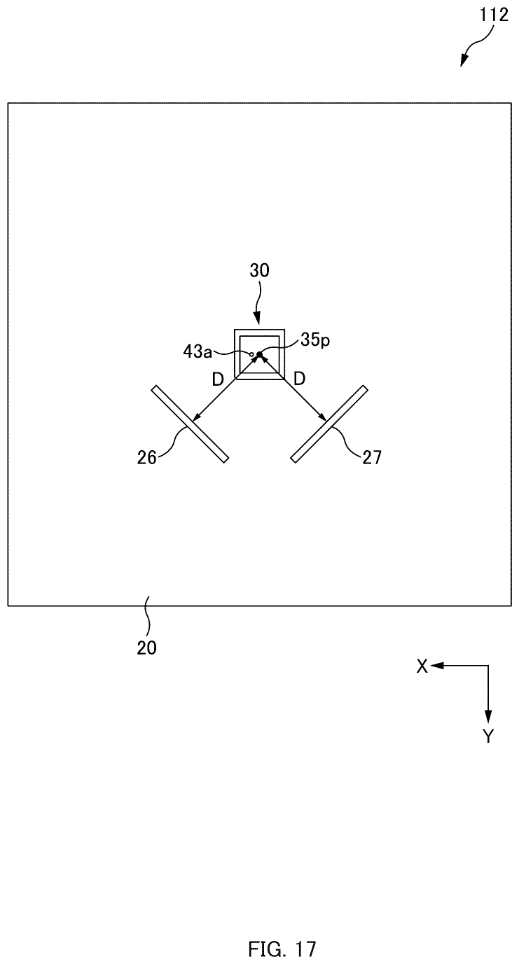

The antenna device 111 in FIG. 16 is provided with the slots 25 and 26 adjacent to each other in the X axis positive direction out of the slots 25 to 28. The antenna device 112 in FIG. 17 is provided with the slots 26 and 27 adjacent to each other in the Y axis positive direction out of the slots 25 to 28.

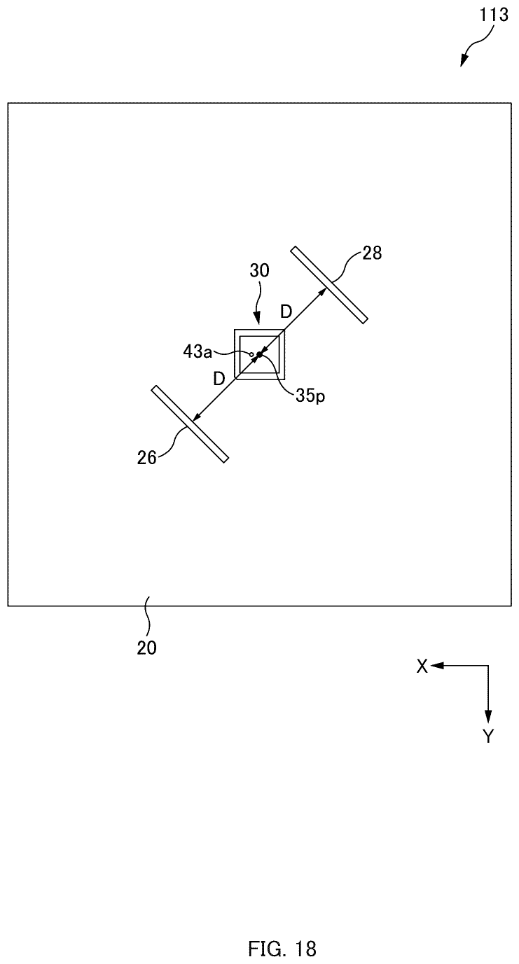

Additionally, the antenna device 113 in FIG. 18 is provided with the slots 26 and 28 so as to face each other with the central point 35p of the radiation element 35 being arranged therebetween out of the slots 25 to 28.

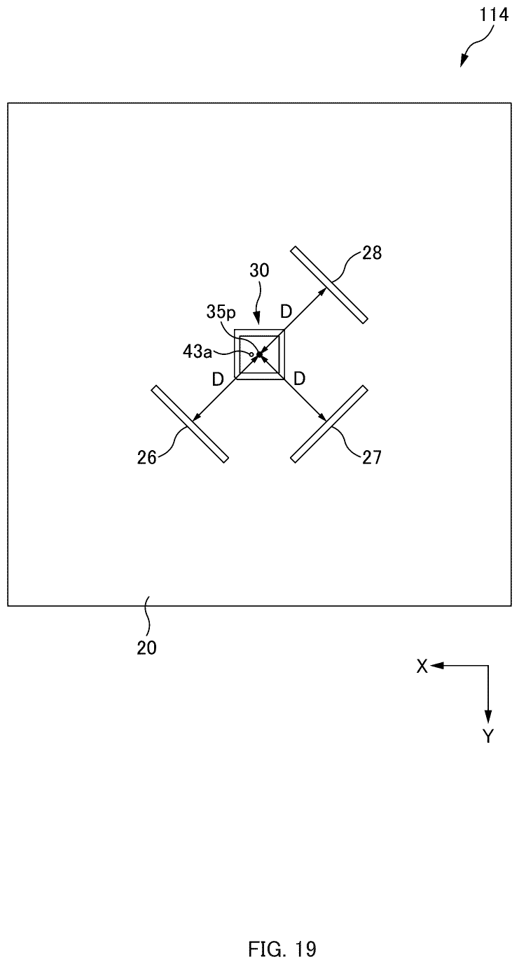

FIG. 19 is a plan view of an antenna device 114 including three slots. The antenna device 114 is provided with the three slots 26 to 28 out of the slots 25 to 28.

The following table is a table illustrating a relationship between the number of slots and the calculation result of the average gain at the elevation angles 0° to 60° of the antenna device. As can be seen from this table, the average gain of the antenna device including at least one slot is greater than the average gain at the elevation angles 0° to 60° in a case of no slot (the antenna device A).

TABLE

| | Average gain (dB) |
|---|---|
| Number of slots | at elevation angles |
| (Antenna device) | 0° to 60° |
| None (Antenna device A) | 2.99 |
| One (Antenna device 110) | 3.15 |
| Two (Antenna device 111) | 3.65 |
| Two (Antenna device 112) | 3.57 |
| Two (Antenna device 113) | 3.05 |
| Three (Antenna device 114) | 3.53 |

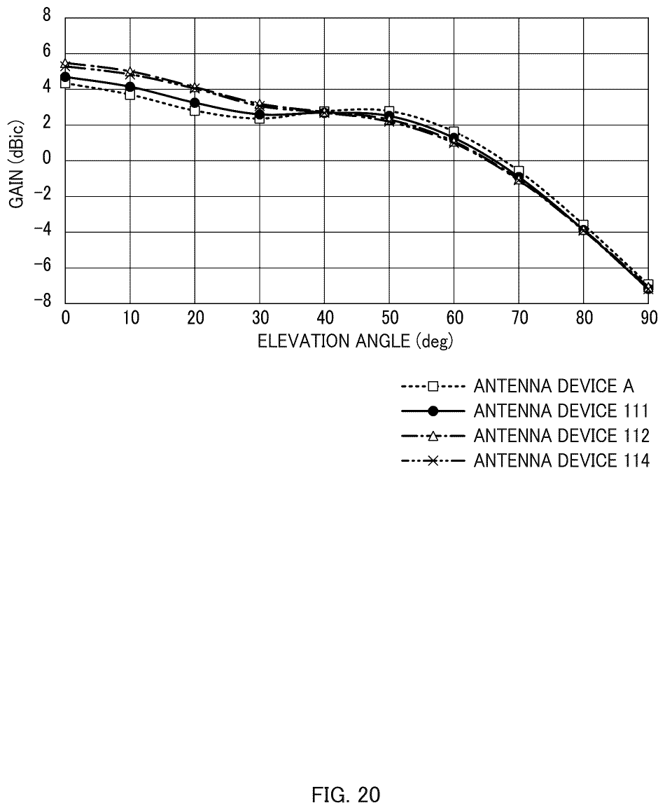

FIG. 20 is a diagram illustrating a relationship between the elevation angle (horizontal axis) and the gain (vertical axis) in no slot and each of the antenna devices 110, 111, and 114. In FIG. 20, a dotted line is a waveform of an antenna device with no slot (the antenna device A), and a solid line, a dashed-dotted line, and a dashed-two dotted line are waveforms of the antenna devices 110, 111, and 114, respectively. Note that, in this case, the antenna device 111 out of the antenna devices 111 to 113 in which the number of the slots is two is illustrated for the sake of convenience.

As illustrated in FIG. 20, at high elevation angles the gain of each of the antenna devices 110, 111, and 114 is greater than the gain of the antenna device A. The gain of each of the antenna devices 110, 111, and 114 then gradually declines as the elevation angle increases from the zenith angle. Accordingly, with at least one slot being provided around the patch antenna 30 of the antenna device, the average gain at the high to middle elevation angles of the antenna device is enhanced, and it is possible to improve the directivity.

### OTHER EMBODIMENTS

Here, an example of a case where a slot is provided in an antenna device that receives radio waves of two frequency bands is described.

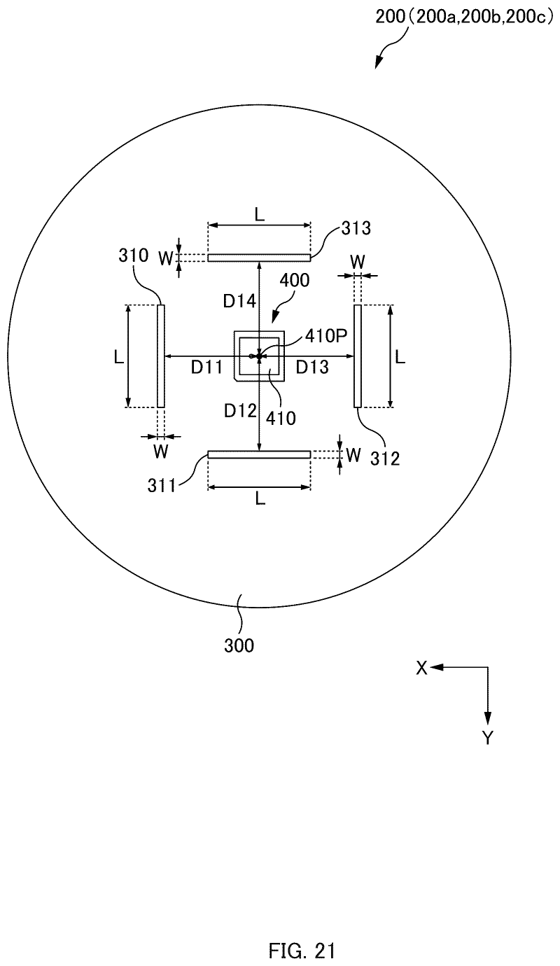

FIG. 21 is a diagram illustrating a plan view of an antenna device 200 that receives radio waves of two frequency bands. The antenna device 200 includes a circular ground plane 300 and a patch antenna 400.

The ground plane 300 is a circular metallic plate with a diameter of 1 m. The patch antenna 400 is provided in substantially the center of the ground plane 300, and slots 310 to 313 are provided around the patch antenna 400. As with the slot 25, the slots 310 to 313 are an opening (a hole) having a quadrangular shape with a length L in the longitudinal direction and a length W in the transverse direction. Note that details of the slots 310 to 313 are described later.

The patch antenna 400 is, for example, an antenna that receives radio waves of frequency bands of 1.2 GHz and 1.6 GHz used in the global navigation satellite system (GNSS). As the patch antenna 400 for the GNSS, a patch antenna of various configurations such as a general one-stage patch antenna, a laminated two-stage patch antenna, and a patch antenna using sheet metal can be used. Note that detailed descriptions of the configuration of the patch antenna 400 are omitted. Additionally, the patch antenna 400 is attached to the ground plane 300 using a configuration similar to the configuration to attach the patch antenna 30 to the ground plane 20.

In FIG. 21, for the sake of convenience, out of two radiation elements included in the patch antenna 400 (a radiation element for 1.2 GHz and a radiation element for 1.6 GHz), only a radiation element 410 for 1.2 GHz is denoted by the reference sign.

The slot 310 is formed in a position separated by a distance D10 from a central point 410p of the substantially quadrangular radiation element 410 in the X axis positive direction. Additionally, in the present embodiment, the slot 310 is provided in the ground plane 300 such that, of the two sides of the slot 310 in the longitudinal direction, the midpoint of the side on the radiation element 410 side lies on an axis extending from the central point 410p in the X axis positive direction.

Note that, in the present embodiment, the patch antenna 400 is designed such that the central point 410p coincides with the center of the patch antenna 400 in the XY plane. Therefore, the “center of the patch antenna 400” is also the central point 410p.

The slots 311 to 313 are formed in the ground plane 300 in the same way as the slot 310. Specifically, the slot 311 is provided in a position separated by a distance D11 from the central point 410p of the radiation element 410 in the Y axis positive direction, and the slot 312 is provided in a position separated by a distance D12 from the central point 410p of the radiation element 410 in the X axis negative direction. Additionally, the slot 313 is provided in a position separated by a distance D13 from the central point 410p of the radiation element 410 in the Y axis negative direction.

As described later in detail, with the antenna device 200, as with the antenna device 10, it is possible to enhance the directivity of the radio waves received by the patch antenna 400 by adjusting the length L of the slots 310 to 313 and the distances D10 to 13, for example.

### ==Antenna Device B (No Slot)==

In this case, first, the gain of an antenna device as a comparative example of the antenna device 200 (hereinafter, referred to as an antenna device B) is calculated. Note that the antenna device B (not illustrated) is the antenna device 200 that is not provided with the four slots 310 to 313.

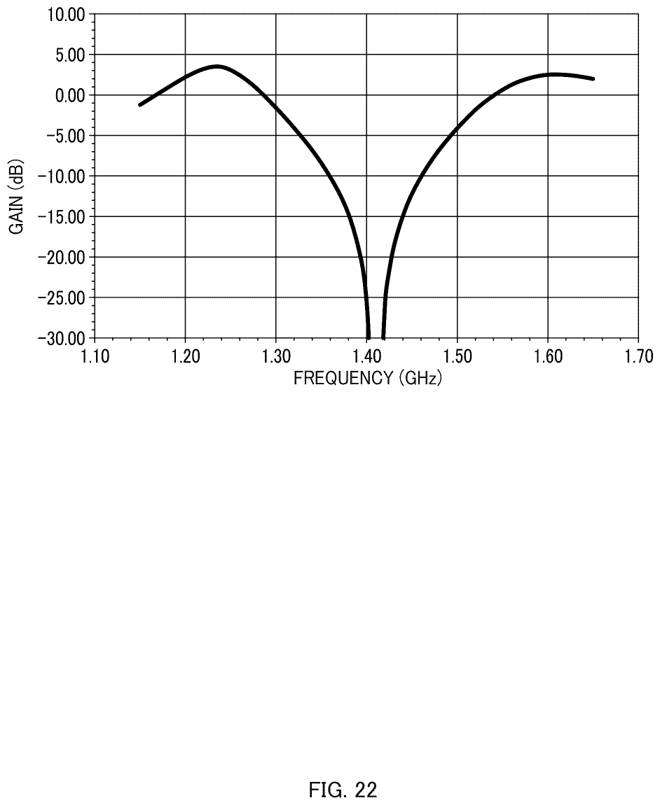

FIG. 22 is a diagram illustrating a relationship between the frequency and the gain in the antenna device B. As illustrated in FIG. 22, the gain of the antenna device B is increased near 1.2 GHz and near 1.6 GHz. Accordingly, with use of such an antenna device B, it is possible to receive the radio waves of the two frequency bands for the GNSS (1.2 GHz band and 1.6 GHz band).

Hereinafter, in the present embodiment, out of the two frequency bands for the GNSS, the frequency of the 1.2 GHz band is referred to as a “first frequency band”, and the frequency of the 1.6 GHz band is referred to as a “second frequency band”.

==Antenna Device 200a==

An antenna device 200a is one form of the antenna device 200 that can further increase the gain of antenna device 200 at the radio waves of the first frequency band. In the antenna device 200a, the length L of each of the slots 310 to 313 is substantially half the operating wavelength of the first frequency band, and the length W is a length sufficiently shorter than the length L.

In this case, the operating wavelength of the first frequency band is, for example, a wavelength corresponding to the center frequency of the first frequency band (for example, substantially 1246 MHz). Therefore, the operating wavelength

A in this case is substantially 240 mm, and thus the length L is substantially 120 mm.

Additionally, although the length W is, for example, 5 mm in the present embodiment, the length W is not limited thereto as long as it is a length that is sufficiently shorter than 120 mm and which also allows the slots 310 to 313 to emit (or reflect) the radio waves of the first frequency band.

Additionally, in the antenna device 200a, each of the distances D10 to D13 is a length substantially half the operating wavelength of the first frequency band (120 mm), for example. Note that, although the distances D10 to D13 are the same, the distances D10 to D13 are not limited thereto as long as they are within a range of substantially one-fourth to substantially three-fourths of the operating wavelength as described using FIG. 9.

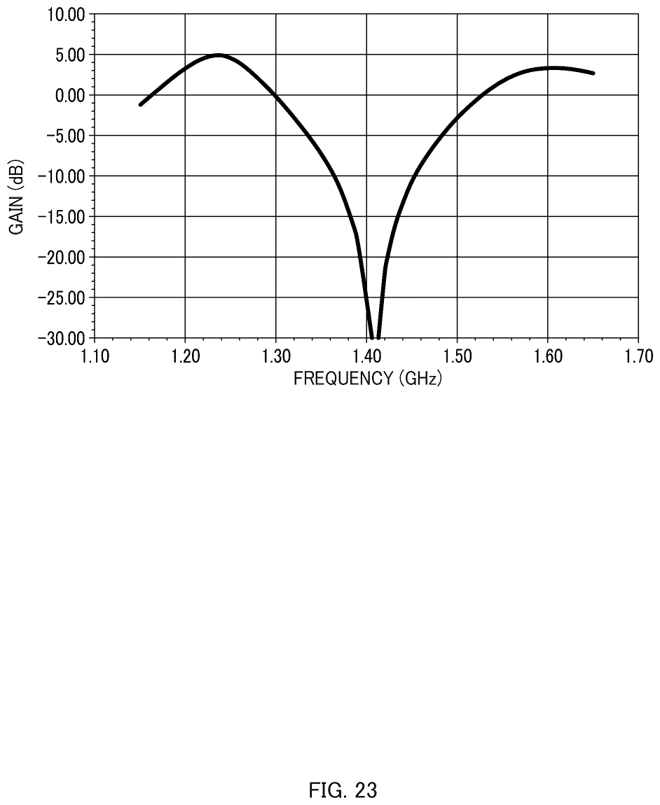

FIG. 23 is a diagram illustrating a relationship between the frequency and the gain of the antenna device 200a. As illustrated in FIG. 23, in the antenna device 200a, the gain of the 1.2 GHz band is greater than the gain of the 1.6 GHz band.

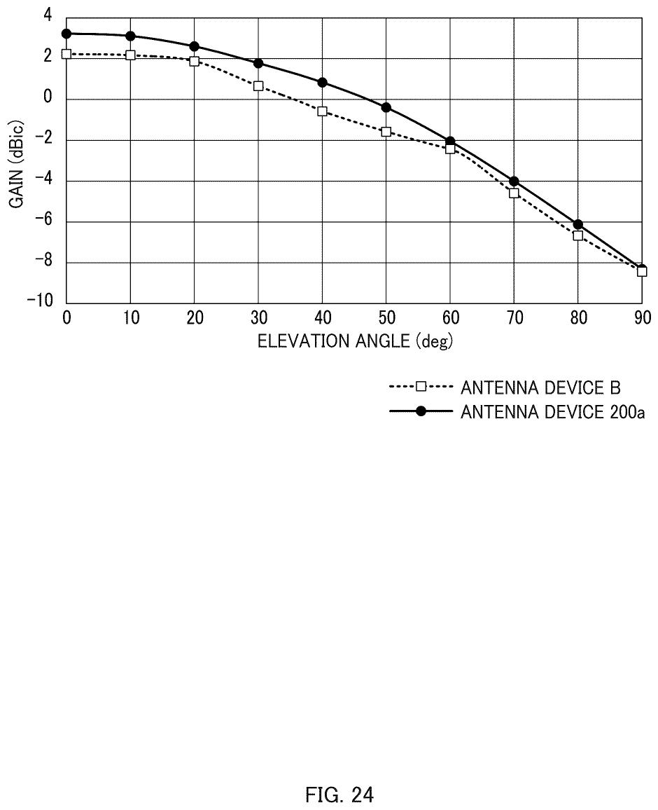

Additionally, FIG. 24 is a diagram illustrating a relationship between the elevation angle (horizontal axis) and the gain (vertical axis) of the antenna device 200a. In FIG. 24, a dotted line is a waveform of an antenna device with no slot (the antenna device B), and a solid line is a waveform of the antenna device 200a.

As illustrated in FIG. 24, at high elevation angles the gain of the antenna device 200a is greater than the gain of the antenna device B. The gain of the antenna device 200a then gradually declines as the elevation angle increases from the zenith angle. Additionally, a calculation result of the average gain at the elevation angles 0° to 60° of the antenna device 200a is 1.64 dB, which is greater than the average gain at the elevation angles 0° to 60° of the antenna device B (0.6 dB).

Accordingly, with the slots 310 to 313 of the length L according to the operating wavelength of the first frequency band being provided around the patch antenna 400 of the antenna device 200a, the average gain at the high to middle elevation angles in the first frequency band is enhanced, and it is possible to improve the directivity.

==Antenna Device 200b==

An antenna device 200b is one form of the antenna device 200 that can further increase the gain of antenna device 200 at the radio waves of the second frequency band. In the antenna device 200b, the length L of each of the slots 310 to 313 is substantially half the operating wavelength of the second frequency band, and the length W is a length sufficiently shorter than the length L.

In this case, the operating wavelength of the second frequency band is, for example, a wavelength corresponding to the center frequency of the second frequency band (for example, substantially 1602 MHz). Therefore, the operating wavelength λ in this case is substantially 187 mm, and the length L is substantially 94 mm.

Additionally, although, the length W is, for example, 5 mm in the present embodiment, the length W is not limited thereto as long as it is a length that is sufficiently shorter than 94 mm and which also allows the slots 310 to 313 to emit (or reflect) the radio waves of the second frequency band.

Additionally, in the antenna device 200b, each of the distances D10 to D13 is a length substantially half the operating wavelength of the second frequency band (94 mm), for example. Note that, although the distances D10 to D13 are the same, the distances D10 to D13 are not limited thereto as long as they are within a range of substantially one-fourth to substantially three-fourths of the operating wavelength as described using FIG. 9.

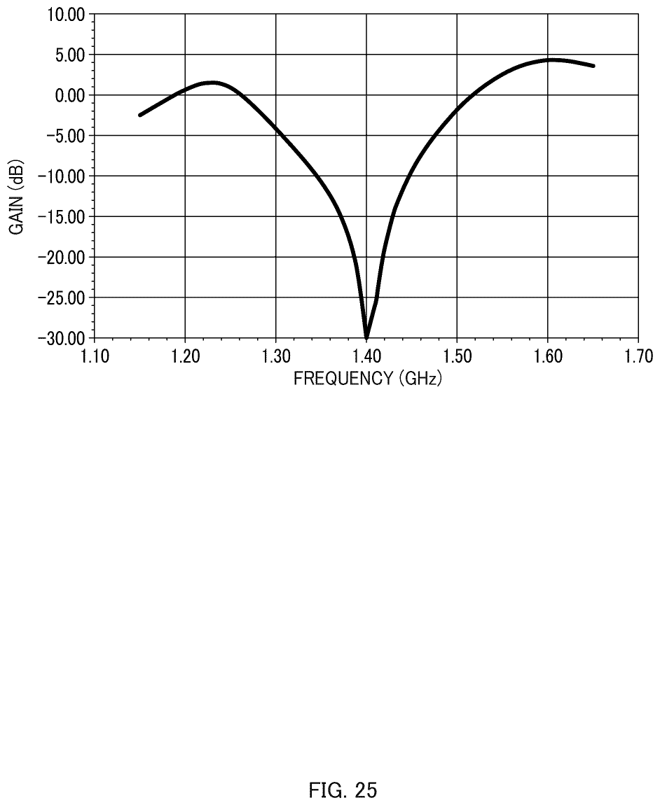

FIG. 25 is a diagram illustrating a relationship between the frequency and the gain of the antenna device 200b. As illustrated in FIG. 25, in the antenna device 200b, the gain of 1.6 GHz band is greater than the gain of 1.2 GHz band.

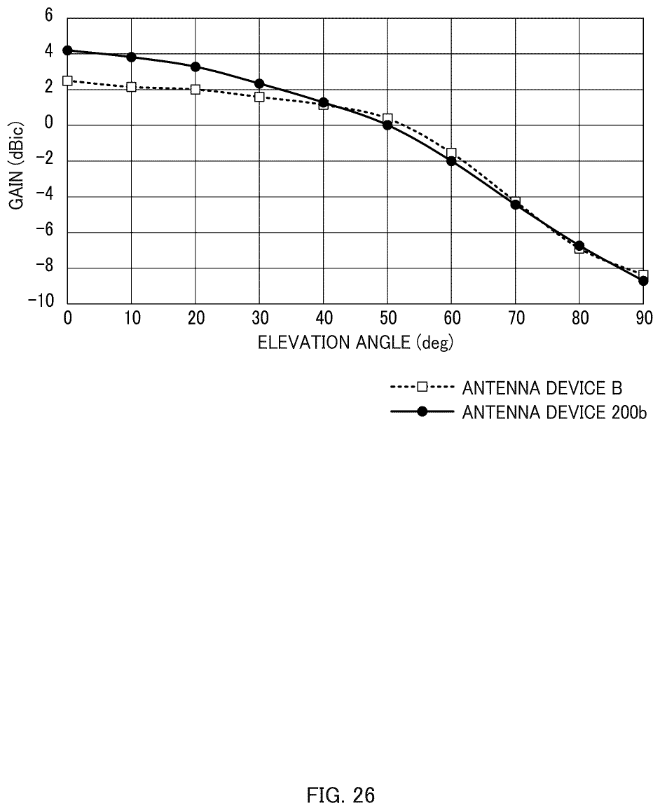

Additionally, FIG. 26 is a diagram illustrating a relationship between the elevation angle (the horizontal axis) and the gain (the vertical axis) of the antenna device 200b. In FIG. 26, a dotted line is a waveform of an antenna device with no slot (the antenna device B), and a solid line is a waveform of the antenna device 200b.

As illustrated in FIG. 26, at high elevation angles the gain of the antenna device 200b is greater than the gain of the antenna device B. The gain of the antenna device 200b then gradually declines as the elevation angle increases from the zenith angle. Additionally, a calculation result of the average gain at the elevation angles 0° to 60° of the antenna device 200b is 2.29 dB, which is greater than the average gain at the elevation angles 0° to 60° of the antenna device B (1.35 dB).

Accordingly, with the slots 310 to 313 of the length L according to the operating wavelength of the second frequency band being provided around the patch antenna 400 of the antenna device 200b, the average gain at the high to middle elevation angles in the second frequency band is enhanced, and it is possible to improve the directivity.

==Antenna Device 200c==

An antenna device 200c is one form of the antenna device 200 that can further increase the gain of the antenna device 200 at the radio waves of the first and second frequency bands. In the antenna device 200c, for example, the length L of each of the slots 310 and 311 out of the slots 310 to 313 is substantially half the operating wavelength of the first frequency band (substantially 120 mm). Additionally, the length L of each of the slots 312 and 313 is substantially half the operating wavelength of the first frequency band (substantially 94 mm). Moreover, the slots 310 to 313 have a length sufficiently shorter than the above-described length L (for example, 5 mm).

Additionally, in the antenna device 200c, the distances D10 and D11 out of the distances D10 to D13 are a length substantially half the operating wavelength of the first frequency band (substantially 120 mm), and the distances D12 and D13 are a length substantially half the operating wavelength of the second frequency band (substantially 94 mm).

Note that, although the length L of all the slots 310 to 313 is illustrated as the same length in FIG. 21 for the sake of convenience, in the antenna device 200c, the length L of the slots 310 and 311 is longer than the length L of the slots 312 and 313. Likewise, out of the distances D10 to D13, the distances D10 and D11 are longer than the distances D12 and 13.

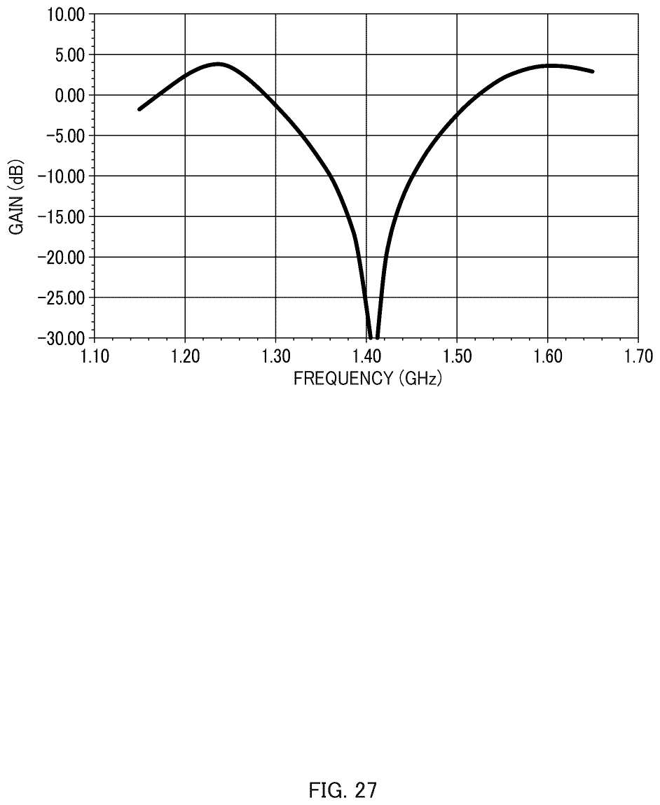

FIG. 27 is a diagram illustrating a relationship between the frequency and the gain of the antenna device 200c. As illustrated in FIG. 27, in the antenna device 200c, the gain of 1.6 GHz band and the gain of 1.2 GHz band are greater than that in FIG. 22. For example, the gain of the frequency at substantially 1240 MHz is substantially 3.50 dB in FIG. 22, but is substantially 3.75 dB in FIG. 27.

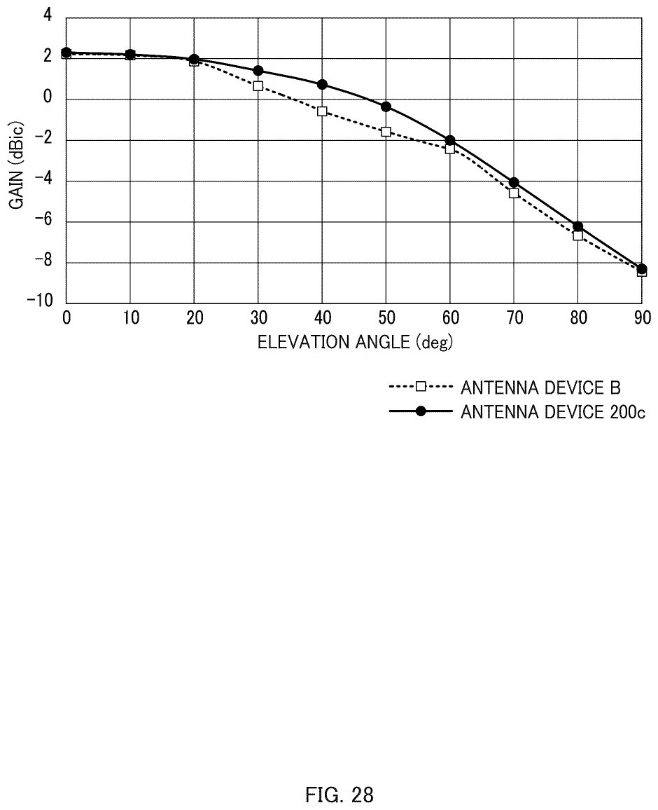

FIG. 28 is a diagram illustrating a relationship between the elevation angle (horizontal axis) and the gain (vertical axis) of the first frequency band of the antenna device 200c. In FIG. 28, a dotted line is a waveform of an antenna device with no slot (the antenna device B), and a solid line is a waveform of the first frequency band.

As illustrated in FIG. 28, at high elevation angles the gain of the antenna device 200c is greater than the gain of the antenna device B. The gain of the antenna device 200c then gradually declines as the elevation angle increases from the zenith angle. Additionally, a calculation result of the average gain at the elevation angles 0° to 60° of the antenna device 200c is 1.11 dB, which is greater than the average gain at the elevation angles 0° to 60° of the antenna device B (0.60 dB).

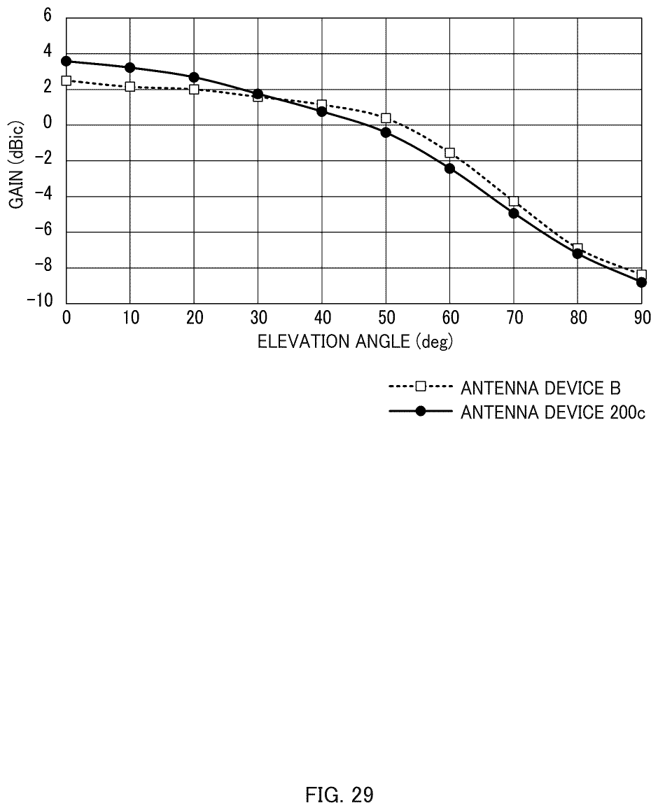

FIG. 29 is a diagram illustrating a relationship between the elevation angle (the horizontal axis) and the gain (the vertical axis) of the second frequency band of the antenna device 200c. In FIG. 29, a dotted line is a waveform of an antenna device with no slot (the antenna device B), and a solid line is a waveform of the second frequency band.

As illustrated in FIG. 29, at high elevation angles the gain of the antenna device 200c is greater than the gain of the antenna device B. The gain of the antenna device 200c then gradually declines as the elevation angle increases from the zenith angle. Additionally, a calculation result of the average gain at the elevation angles 0° to 60° of the antenna device 200c is 1.73 dB, which is greater than the average gain at the elevation angles 0° to 60° of the antenna device B (1.35 dB).

Accordingly, with the slots 310 and 311 of the length L according to the operating wavelength of the first frequency band and the slots 312, 313 of the length L according to the operating wavelength of the second frequency band being provided around the patch antenna 400 of the antenna device 200c, it is possible to enhance the directivity of the first and second frequency bands.

### ==Metallic Portion==

In the above-described antenna devices 10 and 200, the slots are formed in the ground planes 20 and 300; however, where the slots are formed is not limited thereto. For example, at least one of the above-described parasitic slots may be formed in a metallic portion different from the ground plane 20, which is provided around the patch antenna 30 of the antenna device 10. For example, the patch antenna 30 may be provided on resin, and at least one metallic portion (for example, a metallic plate) provided with the slot may be provided around the patch antenna 30. The slot is parasitic in this case as well. Thus, with the slot being provided around the patch antenna 30 using the ground plane 20 or the metallic portion, the average gain at the high to middle elevation angles of the antenna device including the patch antenna 30 is enhanced, and the directivity is improved.

### ==Arrangement Direction of Slots==

Additionally, although in the antenna device 10 for example, the longitudinal direction of each of the slots 25 to 28 is arranged to be parallel to the tangent of the points P1 to P4 of the circle C, slot arrangement is not limited thereto. In the antenna device 10, the longitudinal direction of each of the slots 25 to 28 need not be parallel to the tangent of the points P1 to P4 of the circle C as long as it is a direction that can enhance the directivity of the antenna device 10.

### SUMMARY

The antenna device of the present embodiment is described above. For example, in the antenna device 112, the one slot 26 is provided around the patch antenna 30 in a range of ¼ to ¾. In such a case, the slot 26 can enhance the directivity while increasing the gain at the high elevation angle of the antenna device 112. Additionally, although the slot 26 is provided in the ground plane 20 in the antenna device 112, it may be provided in the metallic portion different from the above-described ground plane 20. It is possible to obtain similar effects also in such a case.

Additionally, although the slot is provided in the ground plane 20 around the patch antenna 30 in the antenna device 10 of the present embodiment, the target antenna need not be a patch antenna. For example, it is possible to obtain similar effects as the present embodiment by providing the slot around a plate-shaped antenna or a linear antenna.

Moreover, in the present embodiment, the slot is provided around the patch antenna 30 within a range from the center of the patch antenna 30 in which the directivity of the patch antenna 30 can be enhanced (hereinafter, referred to as “within a predetermined range”). Note that the “predetermined range” is determined based on the operating wavelength of the radio waves (the signal) received by the patch antenna 30, the area of the ground plane, the structure of the patch antenna 30, and the like, for example.

Furthermore, the antenna device 10 includes as an antenna the patch antenna 30 including the dielectric member 34 and the radiation element 35. With the slot being provided around such a patch antenna 30, it is possible to improve the directivity while increasing the average gain at the high to middle elevation angles of the antenna device 10.

Additionally, for example, the shape of the slot 25 is a quadrangle with the length L in the longitudinal direction and the length W in the transverse direction. For example, although it is also possible to use an oval or a cross shape as the shape of the slot, the quadrangle allows for easy processing of the ground plane 20.

Moreover, for example, the length L of the slots 25 to 28 in the longitudinal direction is substantially half the operating wavelength λ. With the length L of the slots 25 to 28 being set to such a length, for example, it is possible to improve the directivity while further increasing the average gain at the high to middle elevation angles of the antenna device 10 as illustrated in FIG. 7.

Furthermore, in the antenna device 10, the slots 25 to 28 are provided at positions separated from the central point 35p (the center of the patch antenna 30) by substantially one-fourth or more or substantially three-fourths or less of the operating wavelength λ as illustrated in FIG. 9. Therefore, with the slots 25 to 28 being provided in such a range, it is possible to enhance the average gain at the high to middle elevation angles of the antenna device 10 and to improve the directivity more than a case of no slot.

Additionally, as illustrated in FIGS. 1 and 16 to 19, with the antenna device 10 including multiple slots, the antenna device 10 can enhance the average gain at the high to middle elevation angles and improve the directivity.

Moreover, the patch antenna 30 is an antenna that receives satellite signals of the satellite digital audio radio service. With the slots of the present embodiment being provided around such a patch antenna 30, the patch antenna 30 can receive the satellite signal more accurately.

Note that, although the center of the patch antenna 30 coincides with the central point 35p in the present embodiment, they may be different from each other. In such a case, the slot may be installed with the center of the patch antenna 30 being set as a starting point of the distance D.

The above-described embodiments are intended to facilitate an understanding of the present invention and are not intended to limited construal of the present invention.

Additionally, it is needless to say that the present invention can be changed or modified without departing from the intent thereof, and the present invention includes equivalents thereof.

In the present embodiment, “vehicular” means that it can be mounted in a vehicle; for this reason, it is not limited to something attached to the vehicle and also includes something that is brought into the vehicle and used inside the vehicle. Additionally, although the antenna device of the present embodiment is used for a “vehicle” that is a wheeled vehicle, it is not limited thereto and may be used for a mobile vehicle such as a flying vehicle such as a drone, a probe, construction machinery with no wheels, agricultural machinery, and vessels, for example.

### REFERENCE SIGNS LIST

10, 100 to 102, 110 to 114, 200, 200a to 200c antenna device
20, 300 ground plane
21 base portion
25 to 28, 310 to 313 slot
30, 400 patch antenna
31 and 33 pattern
31a circuit pattern
31b ground pattern
32 circuit board
34 dielectric member
35 radiation element
35a to 35d side
35p, 410p central point
40 shield cover
41 through-hole
42 feeder
43a feed point
45 coaxial cable
45a signal line
45b braid
45c solder

1. An antenna device, comprising:
an antenna including a radiation element capable of receiving a signal of a predetermined frequency band; and
a metallic portion, including at least one parasitic slot provided around the antenna.

2. An antenna device, comprising:
a ground plane; and
an antenna provided on the ground plane, wherein
the ground plane includes at least one parasitic slot formed around the antenna.

3. The antenna device according to claim 1, wherein
the slot is provided within a predetermined range around the antenna.

4. The antenna device according to claim 1, wherein
the antenna includes
a dielectric member and
a radiation element provided on the dielectric member.

5. The antenna device according to claim 1, wherein
a shape of the slot is a quadrangle having a longitudinal direction and a transverse direction.

6. The antenna device according to claim 5, wherein
a length in the longitudinal direction is substantially half a wavelength of a desired frequency band.

7. The antenna device according to claim 1, wherein
the slot is provided in a position separated from a center of the antenna by substantially one-fourth or more or substantially three-fourths or less of a wavelength of a desired frequency band.

8. The antenna device according to claim 1, wherein
a plurality of the slots are provided around the antenna.

9. The antenna device according to claim 1, wherein
the antenna is a satellite antenna that receives a satellite signal.

10. The antenna device according to claim 1, wherein
the antenna is a patch antenna.

11. The antenna device according to claim 2, wherein
the slot is provided within a predetermined range around the antenna.

12. The antenna device according to claim 2, wherein
the antenna includes
a dielectric member and
a radiation element provided on the dielectric member.

13. The antenna device according to claim 2, wherein
a shape of the slot is a quadrangle having a longitudinal direction and a transverse direction.

14. The antenna device according to claim 13, wherein
a length in the longitudinal direction is substantially half a wavelength of a desired frequency band.

15. The antenna device according to claim 2, wherein
the slot is provided in a position separated from a center of the antenna by substantially one-fourth or more or substantially three-fourths or less of a wavelength of a desired frequency band.

16. The antenna device according to claim 2, wherein
a plurality of the slots are provided around the antenna.

17. The antenna device according to claim 2, wherein
the antenna is a satellite antenna that receives a satellite signal.

18. The antenna device according to claim 2, wherein
the antenna is a patch antenna.
